(19) United States
(12) Patent Application Publication
(10) Pub. No.: US 2008/0229510 A1
(43) Pub. Date: Sep. 25, 2008

(54) Threading apparatus and method of making

(75) Inventors: Beverly Bahnken, Andover, NJ (US); Joseph Bahnken, Andover, NJ (US)

Correspondence Address: SUGHRUE MION, PLLC, 2100 PENNSYLVANIA AVENUE, N.W., SUITE 800, WASHINGTON, DC, 20037, US

(73) Assignee: MOREX CORPORATION, York, PA (US)

(21) Appl. No.: 11/725,445

(22) Filed: Mar. 20, 2007

(51) Int. Cl. B25F 1/00

(52) U.S. Cl. 7/170; 112/475.01

(57) ABSTRACT

A threading apparatus and a method of making the same are provided. The threading apparatus includes a ribbon having a first edge and a second edge, a threading wire attached to an end of the ribbon, wherein the threading wire extends from the end of the ribbon, and a smooth transition area which forms a transition from the end of the ribbon to the threading wire. With this construction, large holed beads can be threaded onto a ribbon.

### BACKGROUND OF THE INVENTION

1. Field of the Invention

The present invention generally relates to the field of threading beads, and more particularly, relates to a threader which threads larger holed beads onto ribbon of varying widths and styles.

2. Description of the Related Art

Jewelry, craft and scrapbooking makers are always on the look out for new and more efficient tools to aid them in making their products. Companies in the accessory business are also looking for ways to help improve their products. Among many ways to do this, is the threading of a bead or a string of beads on a ribbon. In order to thread beads onto a ribbon, the craft maker must to figure out how to make the end of the ribbon small enough to pass through the holes in the beads. The craft maker must also figure out a way to thread ribbon through the grommets, eyelets, loopy brads, or hole punches on their own. Using a large-eyed needle for threading is one solution but this also limits the width of the ribbon used because it gets too fat for most holes.

Therefore, an innovative product for the craft industry that will allow users the ability to string larger holed beads or charms onto ribbon of varying widths and styles for any number of purposes is needed. Such a product would reduce the time and thought involved in creating jewelry or crafts with ribbon.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above. The present invention provides a bead threading apparatus which can thread and string large holed beads onto a ribbon and a method of making the same.

According to an exemplary embodiment of the present invention, there is provided a method of making a threading apparatus, including providing a ribbon having a first edge and a second edge; inserting a wire through the ribbon at an insertion point near an end of the ribbon and the first edge, forming a first wire portion and a second wire portion, wherein the first wire portion and the second wire portion are on opposite sides of the ribbon; rolling the ribbon, at the end of the ribbon, around the first wire portion, such that the end of the ribbon becomes tapered; wrapping the second wire portion around the end of the ribbon at least two times, forming a wound portion of the second wire, and pulling the wound portion of the second wire portion tight; and twisting the first wire portion and the second wire portion together so that the two wire portions become intertwined, forming a threading wire.

According to another exemplary embodiment of the present invention, there is provided a threading apparatus including a ribbon having a first edge and a second edge; a threading wire attached to an end of the ribbon, wherein the threading wire extends from the end of the ribbon; and a smooth transition area which forms a transition from the end of the ribbon to the threading wire.

### BRIEF DESCRIPTION OF THE DRAWINGS

The above and other aspects of the present invention will become more apparent from the following description of exemplary embodiments, taken in conjunction with the accompanying drawings of which:

FIG. 1 illustrates a ribbon according to an exemplary embodiment of the present invention;

FIG. 2 illustrates a method of inserting a wire through the ribbon according to an exemplary embodiment of the present invention;

FIG. 3 illustrates a method of rolling the ribbon at an end of the ribbon according to an exemplary embodiment of the present invention;

FIG. 4 illustrates positions of first and second wire portions of the wire before a method of wrapping the second wire portion around the end of the ribbon according to an exemplary embodiment of the present invention;

FIG. 5 illustrates a method of wrapping the second wire portion around the end of the ribbon according to an exemplary embodiment of the present invention;

FIG. 6 illustrates positions of the first and second wire portions of the wire before a method of twisting the first and second wire portions together according to an exemplary embodiment of the present invention;

FIG. 7 illustrates a method of twisting the first wire portion and the second wire portion together, forming a threading wire according to an exemplary embodiment of the present invention;

FIG. 8 illustrates methods of applying glue to the end of a ribbon and smoothing the glue according to an exemplary embodiment of the present invention;

FIG. 9 illustrates a threading apparatus before a smooth transition area is created according to an exemplary embodiment of the present invention; and

FIG. 10 illustrates a threading apparatus according to an exemplary embodiment of the present invention.

Throughout the drawings, the same drawing reference numerals will be understood to refer to the same elements, features, and structures.

### DETAILED DESCRIPTION OF THE EXEMPLARY EMBODIMENTS

The matters defined in the description such as a detailed construction and elements are provided to assist in a comprehensive understanding of the embodiment of the invention and are merely exemplary. Accordingly, those of ordinary skill in the art will recognize that various changes and modifications of the embodiment described herein can be made without departing from the scope and spirit of the invention. Also, descriptions of well-known functions and constructions are omitted for clarity and conciseness.

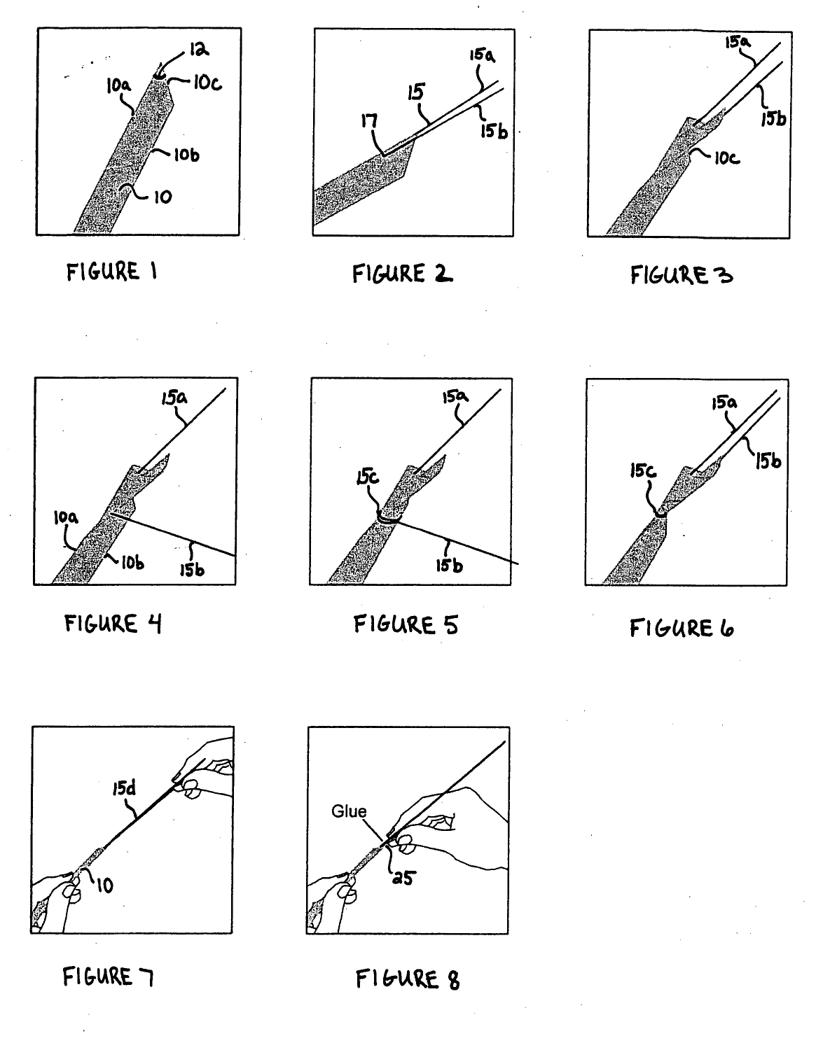

FIG. 1 illustrates a ribbon according to an exemplary embodiment of the present invention.

A ribbon 10 is provided which includes a first edge 10a, a second edge 10b and an end 10c.

According to an exemplary embodiment, the end 10c of the ribbon 10 may be cut at an acute angle 12, such that the length of the first edge 10a is greater than the length of the second edge 10b.

A width of the ribbon may be sufficient to permit the stringing of at least one bead, having a hole with a diameter in a range of about 2 to 5 mm. In particular, the ribbon width determines the size of the hole in which the ribbon will pass through without difficultly.

According to an exemplary embodiment, the width of the ribbon 10 is at least 12.5 mm.

FIG. 2 illustrates a method of inserting a wire through the ribbon according to an exemplary embodiment of the present invention.

A wire 15 is inserted through the ribbon 10 at an insertion point 17 near the end 10c and the first edge 10a, forming a first wire portion 15a and a second wire portion 15b, such that the first wire portion 15a and the second wire portion 15b are on opposite sides of the ribbon 10.

According to an exemplary embodiment, the wire 15 may be folded at the insertion point 17 and the first wire portion 15a and the second wire portion 15b may be pulled toward the end 10c of the ribbon.

FIG. 3 illustrates a method of rolling the ribbon at the end of the ribbon according to an exemplary embodiment of the present invention.

The ribbon 10 is rolled at the end 10c of the ribbon 10 around the first wire portion 15a, such that the end 10c of the ribbon 10 becomes tapered. In particular, the first edge 10a of the ribbon may be used when rolling the ribbon 10 around the first wire portion 15a. Thus, the first wire portion 15a becomes wrapped inside the ribbon 10 as the ribbon 10 is rolled around the first wire portion 15a.

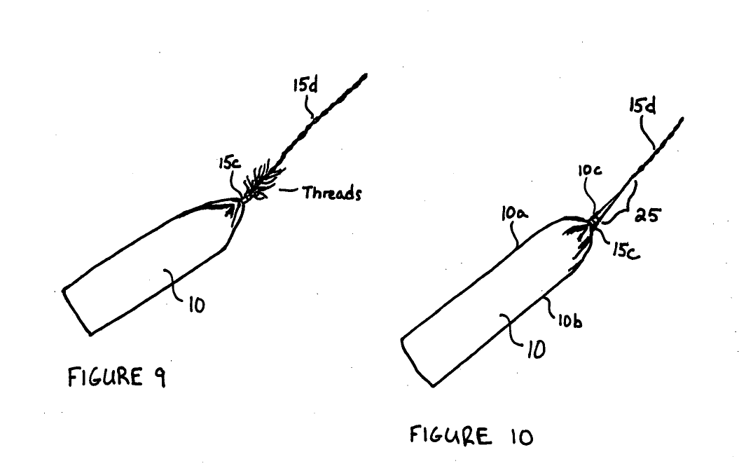

FIG. 4 illustrates positions of first and second wire portions of the wire before a method of wrapping the second wire portion around the end of the ribbon according to an exemplary embodiment of the present invention. In particular, the first wire portion 15a may be pulled toward the end 10c of the ribbon 10, in parallel with the first edge 10a, and the second wire portion 15b may be pulled toward the second edge 10b to a position sufficiently perpendicular to the first edge 10a.

FIG. 5 illustrates a method of wrapping the second wire portion around the end of the ribbon according to an exemplary embodiment of the present invention.

The second wire portion 15b is wrapped around the end 10c of the ribbon 10 at least two times, which forms a wound portion 15c of the second wire portion 15b sufficient to secure the ribbon 10 and the second wire portion 15b together at the wound portion 15c. The wound portion 15c of the second wire portion 15b is pulled tight (as shown in FIG. 6), such that the thickness of the ribbon 10 at the wound portion 15c is reduced.

FIG. 6 illustrates positions of the first and second wire portions of the wire before a method of twisting the first and second wire portions together according to an exemplary embodiment of the present invention. In particular, the second wire portion 15b may be pulled to be adjacent and parallel to the first wire portion 15a to facilitate twisting the first and second wire portions 15a and 15b together.

FIG. 7 illustrates a method of twisting the first wire portion and the second wire portion together, forming a threading wire according to an exemplary embodiment of the present invention.

A threading wire 15d is formed by twisting the first wire portion 15a and the second wire portion 15b together so that the two wire portions become intertwined. The wire twists of the threading wire 15d should be tight enough that they do not restrict the threading of beads on the threading wire 15d. The twists of the wire may be evenly spaced. Once the threading wire 15d is formed, the threading wire 15d may be cut to a desired length, which may be at least 25 mm, to facilitate the threading of beads. For example, more than one bead can be threaded onto the ribbon 10 at a time depending on the length of the threading wire 15d.

The wire 15 may be made of copper or another material with similar tensile strength as that of copper. Also, the length of the wire 15 should be long enough to be bent or folded (e.g., folded in half), wrapped around the end 10c of the ribbon 10 to form the wound portion 15c, and leave a threading wire 15d long enough to load several beads before reaching the part where the threading wire 15d and the ribbon 10 join.

FIG. 8 illustrates methods of applying glue to the end of the ribbon and smoothing the glue according to an exemplary embodiment of the present invention. In particular, glue is applied to the end 10c of the ribbon 10 where the end 10c of the ribbon 10 attaches to the threading wire 15d. The glue is spread to a point beyond the end 10c of the ribbon 10 along the threading wire 15d. The glue is smoothed, such that threads (as shown in FIG. 9) of the ribbon 10 are fixed to each other and to the threading wire 15d, which creates a smooth transition area 25 between the threading wire 15d and the ribbon 10.

The smooth transition area 25 may extend at least 12.5 mm onto the threading wire to ensure the ribbon 10 is sufficiently attached to the threading wire 25 and that a smooth transition point is created between the threading wire 15d and the ribbon 10.

The glue may dry smooth, and not sticky or tacky, so as not to inhibit the threading of beads through the smooth transition area 25. The glue may be clear or opaque, and may also be colored.

The angle 12 directly relates to the thickness of the smooth transition area 25, therefore it may be preferred that the end 10c of the ribbon 10 is cut at an angle of about 30 to 80 degrees in reference to the first edge 10a in order to reduce the thickness of the smooth transition area 25 which will facilitate the threading of beads onto the ribbon 10. Similarly, the number of times the second wire portion 15b is wrapped around the end 10c of the ribbon should not be such that the wound portion 15c inhibits the threading of beads onto the ribbon 10.

FIG. 10 illustrates a threading apparatus according to an exemplary embodiment of the present invention.

A threading apparatus includes a ribbon 10 having a first edge 10a, a second edge 10b and an end 10c, a threading wire 15d attached to the end 10c of the ribbon 10, such that the threading wire 15d extends from the end 10c of the ribbon 10, and a smooth transition area 25 which forms a transition from the end 10c of the ribbon 10 to the threading wire 15d.

The threading wire 15d includes a wire 15 having a first wire portion 15a and a second wire portion 15b, which are twisted together, and thus become intertwined. The wire 15, which is inserted through the ribbon 10 at an insertion point 17 near the end 10c of the ribbon 10 and the first edge 10a, forms the first wire portion 15a and the second wire portion 15b on opposite sides of the ribbon 10.

What is claimed is:

1. A method of making a threading apparatus, the method comprising:
providing a ribbon having a first edge and a second edge;
inserting a wire through the ribbon at an insertion point near an end of the ribbon and the first edge, forming a first wire portion and a second wire portion, wherein the first wire portion and the second wire portion are on opposite sides of the ribbon;
rolling the ribbon, at the end of the ribbon, around the first wire portion, such that the end of the ribbon becomes tapered;
wrapping the second wire portion around the end of the ribbon at least two times, forming a wound portion of the second wire portion, and pulling the wound portion of the second wire portion tight; and
twisting the first wire portion and the second wire portion together so that the two wire portions become intertwined, forming a threading wire.

2. The method of claim 1, wherein providing a ribbon further comprises cutting the end of the ribbon at an acute angle, such that the length of the first edge is greater than the length of the second edge.

3. The method of claim 2, wherein the end of the ribbon is cut an angle between about 30 to 80 degrees in reference to the first edge.

4. The method of making of claim 1, further comprising:
folding the wire at the insertion point and pulling the first wire portion and the second wire portion toward the end of the ribbon; and
cutting the threading wire to a desired length.

5. The method of claim 1, further comprising:
applying glue to the end of the ribbon where the end of the ribbon attaches to the threading wire and spreading the glue to a point beyond the end of the ribbon along the threading wire; and
smoothing the glue, such that threads of the ribbon are fixed to each other and to the threading wire and a smooth transition area is created between the threading wire and the ribbon.

6. The method of claim 1, wherein a width of the ribbon is at least 12.5 mm.

7. The method of claim 1, wherein the wire comprises copper.

8. The method of claim 1, wherein cutting the threading wire comprises cutting the threading wire to a length of not less than about 25 mm, from the end of the ribbon.

9. The method of claim 1, wherein the smooth transition area extends at least 12.5 mm onto the threading wire.

10. The method of claim 1, wherein a width of the ribbon is sufficient to permit the stringing of at least one bead, wherein the bead has a hole having a diameter of about 2 to 5 mm.

11. A threading apparatus comprising:
a ribbon having a first edge and a second edge;
a threading wire attached to an end of the ribbon, wherein the threading wire extends from the end of the ribbon; and
a smooth transition area which forms a transition from the end of the ribbon to the threading wire.

12. The threading apparatus of claim 11, wherein the threading wire comprises a wire inserted through the ribbon at an insertion point near the end of the ribbon and the first edge, forming a first wire portion and a second wire portion on opposite sides of the ribbon, which are twisted together, and thus become intertwined.

13. The threading apparatus of claim 11, wherein the end of the ribbon is cut at an acute angle, such that the length of the first edge of the ribbon is greater than the length of the second edge.

14. The threading apparatus of claim 13, wherein the end of the ribbon is cut an angle between about 30 to 80 degrees in reference to the first edge.

15. The threading apparatus of claim 11, wherein a width of the ribbon is at least 12.5 mm.

16. The threading apparatus of claim 11, wherein the wire comprises copper.

17. The threading apparatus of claim 11, wherein the threading wire extends at least 25 mm from the end of the ribbon.

18. The threading apparatus of claim 11, wherein the smooth transition area comprises glue, which fixes threads of the ribbon to each other and to the threading wire.

19. The threading apparatus of claim 11, wherein the smooth transition area comprises an area of at least 12.5 mm in which the threading wire overlaps with the end of the ribbon.

20. The threading apparatus of claim 11, wherein a width of the ribbon is sufficient to permit the stringing of at least one bead, having a hole therein with a diameter of about 2 to 5 mm.
